(19) United States
(12) Patent Application Publication
(10) Pub. No.: US 2012/0161450 A1
(43) Pub. Date: Jun. 28, 2012

(54) Energy Storage System

(76) Inventor: Justin Bredar Cutts, Mobile, AL (US)

(21) Appl. No.: 12/978,529

(22) Filed: Dec. 24, 2010

(51) Int. Cl. H02K 7/18; F02B 63/04

(52) U.S. Cl. 290/1 C; 290/1 E; 290/1 R

(57) ABSTRACT

An Energy Storage System for the storage of energy by means of lifting a plurality of masses (27) perpendicular to the horizon by supplying electrical or mechanical energy, by means of a plurality of generators (28) or a plurality of reversible compressors or turbines (39) and storing the energy in the elevated masses (27) as potential energy; wherein providing means to recover the stored energy for later use by reversing the energy storage process and said generators (28) or said reversible compressors or turbines (39). An alternate embodiment for the storage of energy uses the potential energy of a plurality of springs to store energy; whereby said springs are deformed from energy of the generators (28) or the reversible compressors or turbines (39) and is stored therein, whereby energy is released to said generators (28) or the reversible compressors or turbines (39) for use at a later time. Another alternate embodiment stores energy in the form of a compressed fluid, gas or air (42), whereby said generators (28) or reversible compressors or turbines (39) compress said fluid, gas or air (42) in a plurality of flexible, reinforced composite bladders (38) submerged underwater; whereby said compressed fluid, gas or air (42) stores energy; wherein said fluid, gas or air (42) stored in said flexible, reinforced composite bladders (38) are subjected to the hydrostatic pressure of the surrounding water (43); thereby the compressed fluid, gas or air (42) is released to said generators (28) or the reversible compressors or turbines (39) when energy is needed at a later time.

### CROSS-REFERENCE TO RELATED APPLICATIONS

### U.S. Patent Documents

| | | |
|---|---|---|
| 7,770,331 | Aug. 10, 2010 | Halloran |
| 4,873,828 | Oct. 17, 1989 | Laing, et al. |
| 7,299,633 | Nov. 27, 2007 | Murphy, et al. |
| 7,051,529 | May 30, 2006 | Murphy, et al. |
| 7,554,278 | Jun. 30, 2009 | Wegner-Donnelly, et al. |

### FEDERALLY SPONSORED RESEARCH AND DEVELOPMENT

Not Applicable

### SEQUENCE LISTING OR TABLES

Not Applicable

### BACKGROUND OF THE INVENTION

1. Field Of Invention

The present invention relates to the capture and recovery of energy generated from conventional and renewable methods. Affordable energy storage solutions are an indispensable component of renewable and conventional power plant design solutions. Inexpensive and reliable energy storage is now readily available to power producers and developers of both conventional and renewable power plants regardless of geographical location. As states look to meet renewable energy standards they are finding that most of these methods of energy production are plagued by periods of interrupted and unscheduled service due to lack of wind, sunshine, or other unplanned events.

Conventional energy production techniques utilize energy storage during periods of lesser demand so that the energy may be recovered during periods of peak demand. The use of stored energy technology defers or reduces the building of additional production plants traditionally required to meet this growing demand. Power producers charge consumers less for the use of energy during periods of lesser demand. As a result, producers can meet cheaper energy production alternatives through energy storage during these cheaper periods and supply the power grid with the stored energy when power production is more expensive. This in effect can subsidize a portion of the cost of the energy storage system.

Several technologies exist for the storage of energy. The least expensive would be the use of abandoned underground salt caverns for compressed air storage and the use of existing water reservoirs utilizing an elevation change between connected reservoirs. As appealing as these solutions may be, they do have drawbacks. Salt caverns are limited to geographic locations on the planet and as a result of this limitation power producers are restricted in their use. Reservoirs require vast amounts of real estate and different water temperatures in the connected reservoirs can have ecologic repercussions. Both of these systems require mechanical components, all of which are expensive to construct. Furthermore, fresh water is a precious natural resource which is not suitable for all locations where energy storage is needed.

A more expensive technology, although costs are decreasing as the technology matures, is the use of batteries to store large amounts of energy. Battery technology has yet to become a cost effective solution for the storage of large amounts of energy. Batteries also have large quantities of dangerous chemicals which have environmental implications regarding their use and disposal. Additionally, batteries loose storage capacity over time and are subject to constant maintenance and replacement.

Flywheel storage technology is an expensive storage technology as well. This technology uses flywheels to stores energy in the inertia of a spinning mass. These items are expensive to manufacture and are subjected to frictional losses which decrease the energy storage efficiency over long periods of time.

Commercial renewable energy is becoming more common place in energy producer portfolios and is becoming less expensive through technologic innovations. A renewable energy storage technology for the storage of large amounts of energy is through the use of molten salts. Molten salts store heat efficiently and have been used in solar thermal storage systems to provide heat for the generation of steam to power solar turbines during periods without sunlight. This technology is expensive and is limited to plants which are designed to contend with large amounts of heat energy; namely concentrating solar thermal power plants. However, this technology has not been subjected to extensive industry testing and may be plagued by reliability issues.

Further exacerbating the selection of affordable energy storage solutions are new governmental regulations mandating their use. One such regulation has been passed at the time of this writing by the state of California. The state recently mandated private power producers to have energy storage facilities of 5% and 10% of their generating capacity by the years 2015 and 2020, respectively. The approval of over 4 gigawatts of commercial solar power plants in the last 4 months of 2010 in California alone would require 400 megawatts of storage capacity if 2020 laws were applicable. Current technologies do not provide affordable, reliable, and environmentally responsible solutions for the widespread implementation of energy storage facilities regardless of geographic location.

2. Discussion of Prior Art

Molten salt thermal storage is only provided as a reference to the economic viability of the claims contained herein.

Potential energy storage system shown in U.S. Pat. No. 7,770,331 utilizes hydraulic cylinders for the application of and the retrieving of stored energy. Potential energy in the claims contained herein, with the exception for use with a pendulum, is applied and retrieved by methods other than hydraulic cylinders. As such, greater amounts of power are stored with the same amount of mass by elevating the mass to a greater height than is possible with a hydraulic ram.

Energy storage for off peak electricity utilizes an expensive, vertical cylinder with a flexible membrane submerged in water capable of resisting large hydrostatic forces due to hydrostatic pressure exerted from the surrounding water on the air contained therein. The advantage of the patent claims contained herein is the utilization of the same hydrostatic pressure head as U.S. Pat. No. 4,873,828; However, it differs in that the use of an expensive, fabricated cylindrical structure in the prior art is replaced by an impervious, flexible membrane or a rigid, dished head.

Load-lifting apparatus and method of storing energy for the same, U.S. Pat. No. 7,554,278, requires the use of an outside energy storage device to be powered by an external power source or from regenerative breaking from an elevator or a crane; whereby stored energy assists in the lifting of said elevator or crane. The relative claims contained herein utilize an elevated mass for the storage of potential energy, not an outside energy storage source.

### OBJECTS AND ADVANTAGES

Accordingly, besides the objects and advantages of the Energy Storage System as described in my above patent, several objects and advantages of the present invention are:

a. low cost per megawatt-hour of storage

b. reliable, simplistic design elements

c. indefinite energy storage without system efficiency degradation

d. potential energy designs are not limited to hydraulic ram stroke length

e. a multitude of configurations allow for customized installation

f. scalability of size to meet an unlimited amount of storage

g. ocean and land based configurations result in energy storage solutions for any location

h. designs are independent upon natural resources and geologic formations

i. designs do not threaten sensitive environments

### SUMMARY

In accordance with the present invention the Energy Storage System provides numerous methods and configurations by which energy, in the form of potential energy or compressed fluid, gas or air as a result of a hydrostatic head, is stored until needed later. This technology provides the power producing industries, of both conventional and renewable power plant designs, inexpensive, and reliable options regarding the expansion of existing energy portfolios or to meet the energy storage requirements of modern renewable energy policies.

### DRAWINGS

### Figures

FIG. 1 shows the elevation view of the Energy Storage System for use with a plurality of weighted objects with no potential energy stored featuring winches and sheaves for the storage of energy; profile view is the same.

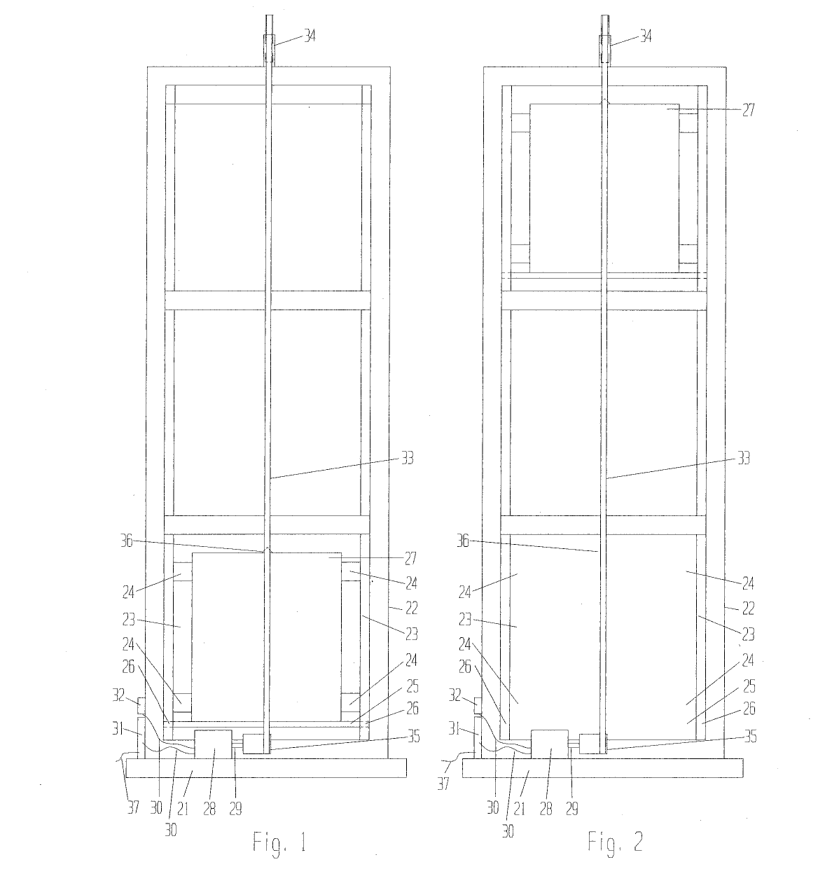

FIG. 2 shows the elevation view of the Energy Storage System for use with a plurality of weighted objects in the stored potential energy position featuring winches and sheaves for the release of energy; profile view is the same.

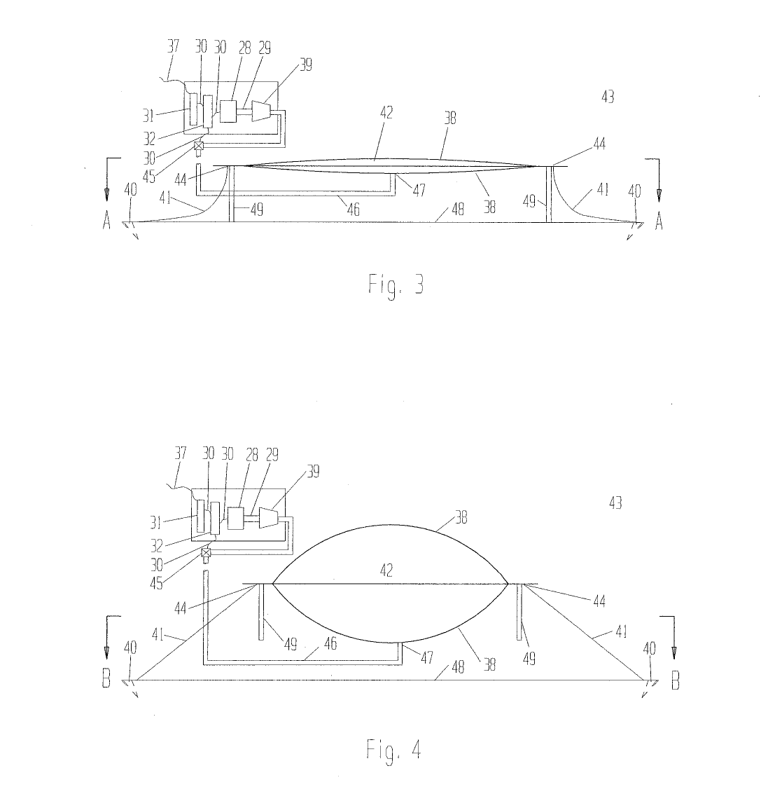

FIG. 3 shows the elevation view of the Energy Storage System for use with a plurality of flexible, reinforced composite bladders without compressed fluid, gas or air stored; profile view is the same.

FIG. 4 shows the elevation view of the Energy Storage System for use with a plurality of flexible, reinforced composite bladders with compressed fluid, gas or air stored; profile view is the same.

FIG. 5 shows the plan view Section A-A of the Energy Storage System for use with a plurality of flexible, reinforced composite bladders without compressed fluid, gas or air stored; profile view is the same.

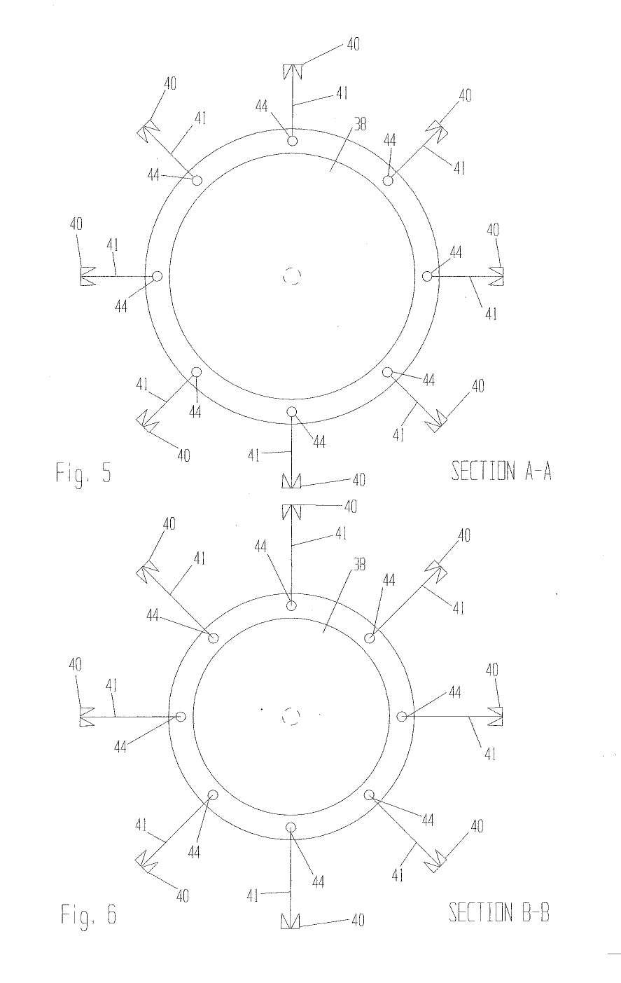

FIG. 6 shows the plan view SectionB-B of the Energy Storage System for use with a plurality of flexible, reinforced composite bladders with compressed fluid, gas or air stored; profile view is the same.

### DRAWINGS

### Reference Numerals

21 foundations
22 rigid support structure
23 guide rails
24 guide devices
25 latches
26 latch receptacles
27 masses
28 generators
29 rotational shafts
30 electrical wires
31 electrical buses
32 control system
33 drive tension members
34 sheaves
35 winches
36 drive tension member clips
37 power generating device wires
38 flexible, reinforced composite bladders
39 reversible compressors or turbines
40 anchors
41 anchor tethers
42 fluid, gas or air
43 water
44 mooring attachment points
45 valves
46 conduits
47 drain
48 seabed
49 legs

### DETAILED DESCRIPTION

### Preferred Embodiment

### FIGS. 1 and 2

The preferred embodiment of the present invention, Energy Storage System, is shown for use with a weighted object in FIG. 1, elevation, before energy is stored. The Energy Storage System shown is composed of the foundations 21 for the support of a rigid support structure 22. The guide rails 23 are fixedly attached to the rigid support structure 22. The guide devices 24 are slidably disposed to the guide rails 23, and affixed to the masses 27. The latches 25 are attached to the masses 27 and connect to the latch receptacles 26 for securing the masses 27 to the rigid support structure 22. Components of the power system are the power generating device wires 37 which supply power to or from the generators 28 which turn or are turned by the rotational shafts 29. The control system 32 regulates operation of the system. The electrical buses 31 perform signal alterations and any other power modifications required for operation. The electrical wires 30 connect the electrical components and control the winches 35 which are coupled to the rotational shafts 29 so as to move the drive tension members 33 around the sheaves 34; wherein the drive tension member clips 36 connect the masses 27 to the drive tension members 33.

FIG. 2 shows the masses 27 at a higher position in the rigid support structure 22; thus storing potential energy in the elevated masses 27.

### Operation—FIGS. 1 and 2

Energy storage of the preferred embodiment of the present invention, Energy Storage System, as shown for use with a weighted object in FIG. 1, elevation, occurs best when the power generating device wires 37 provide electrical energy to the generators 28 thereby providing torque to the rotational shafts 29 and turning the winches 35 which in turn apply tension to the drive tension members 33 and the drive tension member clips 36 via the sheaves 34, thus elevating the masses 27. The electrical wires 30 provide the power to and from the electrical buses 31, the control system 32, the winches 35, and the latches 25, disengaging said latches 25 from the latch receptacles 26, which elevate the masses 27 when an excess of power is available and its storage is desired for later use. The guide devices 24 transmit lateral forces to the rigid support structure 22 and into the foundations 21 via the guide rails 23 from the masses 27.

The discharge of stored energy of the preferred embodiment of the present invention, Energy Storage System, as shown for use with a weighted object in FIG. 2, elevation, occurs best when the latches 25 are removed from the latch receptacles 26 by the control system 32, releasing the elevated masses 27 into a controlled fall, thereby applying tension to the drive tension members 33, the drive tension member clips 36 and rotating the sheaves 34, the winches 35, the rotational shafts 29 and the generators 28. Energy from the generators 28 is transferred to the electrical buses 31 via the electrical wires 30 and to the power generating device wires 37 where the energy is then used by conventional methods.

### Description and Operation of Alternate Embodiments

### FIGS. 3 Through 6

The storage of energy in the alternate embodiment of the present invention, Energy Storage System, is shown for use with a compressed fluid, gas or air 42 in FIGS. 3 and 5, elevation and plan, before energy is stored. The system installation is such that the flexible, reinforced composite bladders 38 are submerged under water 43; thereby providing a hydrostatic pressure on the flexible, reinforced composite bladders 38 and the fluid, gas or air 42 contained therein. The anchors 40 attached to the anchor tethers 41 secure the flexible, reinforced composite bladders 38 to the seabed 48 by mooring attachment points 44; wherein the flexible, reinforced composite bladders 38 rest on the legs 49 which are disposed to the seabed 48. The location of the conduits 46 provide means for a drain 47 allowing for the removal of any accumulated fluid, gas or air 42. The Energy Storage System shown operates when electrical energy from the power generating device wires 37 travels to the electrical buses 31 and the control system 32 controlling the valves 45 and the reversible compressors or turbines 39, then to the generators 28 by way of the electrical wires 30 converting the energy to mechanical energy; thereby compressing the fluid, gas or air 42. Power from the generators 28 then turns the rotational shafts 29 and the reversible compressors or turbines 39; thereby compressing the fluid, gas or air 42 for transport via conduits 46 for storage in the flexible, reinforced composite bladders 38.

The release of energy using the alternate embodiment of the present invention, Energy Storage System, is shown for use with a compressed fluid, gas or air 42 in FIGS. 4 and 6, elevation and plan, after energy is stored. Release of stored energy happens by reversing the process of energy storage. This occurs when the valves 45 are opened by the control system 32. As a result, the hydrostatic head of the water 43 forces the compressed fluid, gas or air 42 out of the flexible, reinforced composite bladders 38, through the conduits 46 and to the reversible compressors or turbines 39, and the valves 45, rotating the rotational shafts 29 and thus the generators 28; thereby generating electricity which ultimately travels to the power generating device wires 37 after passing through the electrical buses 31.

### CONCLUSION, RAMIFICATIONS, AND SCOPE

Thus, it should be apparent that the energy storage devices described herein provide reliable, yet economical energy storage solutions. As a result of the widespread implementation of this energy storage technology everyone will benefit through affordable energy prices and a cleaner environment, not just commercial power producers and renewable energy hobbyists. Accordingly, the scope of the invention should be determined not by the embodiments illustrated, but by the appended claims and their legal equivalents.

I claim:

1. An Energy Storage System for use with a weighted object providing means for the storage and recovery of energy in the form of potential energy produced from a renewable or conventional energy production method; thereby lifting and lowering a plurality of masses perpendicular or at an inclined angle with respect to the horizon; thereby storing energy during lifting of said masses and recovering energy during lowering thereof, comprising:
a plurality of rigid support structures; thereby providing means for supporting said masses;
a plurality of foundations; thereby providing means for supporting said rigid support structures;
a plurality of guide rails disposed to said rigid support structures;
a plurality of guide devices slidably disposed to said guide rails and contiguous to said masses;
thereby providing means for resisting lateral translation, thereof; thereby reducing friction thereof; thereby increasing the efficiency and reliability of said energy storage system;
a plurality of latches disposed to said masses; thereby providing means for securing said masses at a particular elevation;
a plurality of latch receptacles disposed in said rigid support structure; thereby said latches when disposed to said latch receptacle secure said masses, thereof; thereby storing a fixed amount of said potential energy indefinitely thereof;
a plurality of energy conversion devices for the conversion of mechanical or electrical energy from renewable or conventional energy production method to rotational energy by a plurality of means of reversible hydraulic pumps, pneumatic turbines, electric motors, or generators;
a plurality of said energy conversion devices for the conversion of rotational energy to mechanical or electrical energy by a plurality of means of reversible hydraulic pumps, pneumatic turbines, electric motors, or generators;
a plurality of means for the transmittance of rotational energy to a plurality of rotational shafts;
a plurality of means for the conveyance of electrical energy; thereby a plurality of electrical wires convey electrical energy to/from said energy conversion devices;
a plurality of electrical buses; thereby said electrical buses provide means for the conversion of electrical energy;
a plurality of conduits; thereby said conduits convey a working fluid to said energy conversion devices;
a plurality of control systems; thereby said control systems automate said energy storage system;
thereby said control systems maximize the efficiency thereof;
means for connecting the energy storage system to a power grid; thereby providing means for the conveyance of energy to or from the energy storage system;
whereby, the renewable or conventional energy source applies energy to said energy conversion devices; thereby supplying rotational energy to said rotational shafts; thereby providing means for the lifting of said masses such that the storage of said potential energy is obtained in the elevation thereof;
whereby, when energy is needed the lowering of said masses releases the said stored potential energy contained therein, heretofore.

2. The apparatus of claim 1, further providing a plurality of drive tension members; thereby said drive tension members are contiguous with a plurality of sheaves; thereby said drive tension members are disposed around said winches; wherein said drive tension members convey energy from said energy conversion devices to said masses for the movement thereof;
whereby, the renewable or conventional energy source applies energy to said energy conversion devices; thereby supplying rotational energy to said rotational shafts; thereby rotating said winch drums; thereby winding the drive member around said winch drum; thereby reducing the span of the drive member between said masses and the winches; thereby providing means for the lifting of said masses such that the storage of said potential energy is obtained in the elevation of said masses;
whereby, when energy is needed the lowering of said masses releases the stored potential energy contained therein, heretofore.

3. The apparatus of claim 1, providing means for altering the rate of change of ascent/descent of said masses; thereby providing means for adjusting mechanical energy input and output of said energy storage system;
whereby, the efficiency of said energy conversion devices may be optimized by adjusting the rate of elevation change of said masses.

4. The apparatus of claim 1, further providing a plurality of rack and pinion gears; wherein the rack gears are disposed to said masses, said pinion gears are disposed to said rigid support structure and said rotational shafts; thereby composing a drive system for moving said masses;
wherein energy from said energy conversion devices drives the pinion gears; thereby raising the elevation of said masses; therein storing potential energy; wherein released potential energy from the elevated masses drives the pinion gears; thereby lowering the elevation of said masses;
therein releasing potential energy to said energy conversion devices;
whereby, the renewable or conventional energy sources applies energy to said energy conversion devices; thereby supplying rotational energy to said rotational shafts; thereby supplying the rotational energy to said pinion gears; thereby providing means for the lifting of said masses such that the storage of potential energy is obtained in the elevation therein;
whereby, when energy is needed the lowering of said masses is released the stored potential energy contained therein, heretofore.

5. The apparatus of claim 1, further providing means for a working fluid to deliver energy from said energy conversion devices to said masses by the raising thereof; further including means for the said working fluid to deliver the stored potential energy from said masses to said energy conversion devices; thereby composing a drive system for moving said masses, comprising:
a plurality of pressure containment devices; wherein said containment devices are composed of vessels, or conduits;
whereby, the renewable or conventional energy source applies energy to said energy conversion devices; thereby supplying rotational energy to said rotational shafts; thereby compressing said working fluid disposed in said reversible pumps; wherein said working fluid rotates said energy conversion devices disposed to the pinion gears disposed to said rigid support structure; thereby a plurality of valves; wherein said valves control flow of said working fluid in said conduits;
thereby providing means for the lifting of said masses such that the storage of potential energy is obtained in the elevation thereof;
whereby, when energy is needed said masses are lowered releasing the stored potential energy contained therein, heretofore.

6. The apparatus of claim 1, further providing a plurality of friction reducing devices disposed to said guides and said masses; thereby reducing friction heretofore;
whereby, the use of said friction reducing devices disposed to said guides increases the efficiency of said energy storage system.

7. The apparatus of claim 1, further providing a plurality of means to aid in the efficiency of storing or releasing energy from the energy storage system; wherein said means are composed of hydraulic systems, friction systems, pneumatic systems, energy storage systems for use with weighted objects, or flywheels;
whereby, said devices aid in the transference of energy to or from said energy storage system.

8. The apparatus of claim 1, further including means for the storage of potential energy when positioned on a ship or offshore structure; thereby said ship or offshore structure elevates said mass as a result of the vessel motions; thereby said masses are positioned higher with respect to said foundations as a result of the vessel gaining elevation on a passing wave; thereby storing energy in the elevation increase of said masses; thereby the system contains said energy conversion devices for the transfer of potential energy to a working fluid; wherein a mechanical or electrical device assists in the lifting of said masses; wherein the energy is recovered by the lowering thereof; thereby providing a plurality of pendulum masses; wherein a plurality of said energy conversion devices transfer energy to/from said pendulum masses; thereby providing additional means for the pendulum to remain stationary; wherein the vessel rotates around the stationary pendulum;
whereby, rotational energy from the vessel motions moves a pendulum mass; thereby compressing a working fluid contained in a hydraulic ram for the transference of energy to said energy conversion devices.

9. The apparatus of claim 1, further providing means for the erection of said rigid support structure, said foundations and the associated equipment; wherein said rigid support structures are partially erected; wherein said energy conversion devices are installed; wherein the associated energy systems are installed; thereby providing means to transfer energy so that the system components may be moved into position; thereby means for erecting said rigid support structures and said foundations are provided by partial erection thereof;
whereby, partially erected said rigid support structures and said foundations provide erection foundations for said rigid support structures and said foundations; thereby additional means for transporting the construction equipment and the system components is provided by said energy conversion devices and the associated equipment.

10. The apparatus of claim 1, further providing means for a plurality of conveyors; wherein said conveyors are composed of conveying equipment or power screw devices; thereby said masses are moved thereof.

11. An Energy Storage System for use with a plurality of springs providing means for the storage and recovery of energy in the form of potential energy produced from a renewable or conventional energy production method; thereby potential energy is stored in the deformed spring material; thereby potential energy is stored during compressing, extending or coiling of said spring and is released when said spring returns to its original shape;
a plurality of rigid support structures and foundations;
a plurality of latches disposed to said springs providing means for securing in a deformed position thereof;
a plurality of latch receptacles disposed in said rigid support structure; thereby said latches secure said springs when disposed to said latch receptacle; thereby storing a fixed amount of said potential energy indefinitely in the deformed spring materials;
a plurality of energy conversion devices for the conversion of mechanical or electrical energy from said renewable or conventional energy production method to rotational energy by a plurality of means of reversible hydraulic pumps, pneumatic turbines, electric motors, or generators;
a plurality of said energy conversion devices for the conversion of rotational energy to mechanical or electrical energy by a plurality of means of reversible hydraulic pumps, pneumatic turbines, electric motors, or generators;
a plurality of means for the transmittance of the rotational energy to a plurality of rotational shafts;
a plurality of means for the conveyance of electrical energy to or from the reversible electric motors and generators;
a plurality of electrical buses;
a plurality of control systems; thereby said control systems automate said energy storage system;
thereby said control systems maximize the efficiency thereof;
a plurality of means for the transmittance of the rotational energy from said rotational shafts to said springs;
means for connecting the energy storage system to a power grid; thereby providing means for the conveyance of energy to or from the energy storage system;
whereby, the renewable or conventional energy source applies energy to said energy conversion devices; thereby supplying rotational energy to said rotational shafts; thereby providing means for the deformation of said springs such that the storage of potential energy is obtained in the deformed material of said spring;
whereby, when energy is needed the deformed spring material releases the stored potential energy contained thereof.

12. The apparatus of claim 11, further providing a plurality of means to aid in the efficiency of storing or releasing energy from the energy storage system; wherein said means are composed of hydraulic systems, friction systems, pneumatic systems, energy storage systems for use with weighted objects, or flywheels;
whereby, said devices aid in the energy transfer efficiency to/from the energy storage system.

13. The apparatus of claim 11, further including means for the storage of potential energy when positioned on a ship or offshore structure; thereby rotational energy is transferred from said ship or offshore structure motions through a pendulum mass to said springs; thereby said mass is positioned higher with respect to said foundations as a result of the vessel motions due to a passing wave; thereby storing energy in the deformed material of said springs; wherein the energy is stored in said springs; wherein the energy is recovered when material returns to its original shape before deformation; thereby providing additional means for the pendulum to remain stationary; wherein the vessel rotates around the stationary pendulum.

14. The apparatus of claim 11, further including a plurality of winches, gear assemblies, sprockets, power screw assemblies, pumps, turbines, conveyors, compressors, or other mechanical assemblies; thereby transferring energy to/from said springs.

15. An Energy Storage System for use with a compressed fluid, gas, or air providing means for the storage and recovery of energy produced from a renewable or conventional energy production method; thereby said energy is stored under water; thereby said water exerts a hydrostatic pressure on a plurality of flexible, reinforced composite bladders comprising:
a plurality of moorings to the seabed;
a plurality of mooring attachment points on said flexible, reinforced composite bladders; thereby said mooring attachment points structurally reinforce said flexible, reinforced composite bladders;
a plurality of flexible conduits;
a plurality of valves; thereby controlling flow of said fluid, gas, or air thereof;
a plurality of energy conversion devices for the conversion of mechanical or electrical energy from said renewable or conventional energy production method to rotational energy by a plurality of means of reversible hydraulic pumps, pneumatic turbines, electric motors, or generators;
a plurality of said energy conversion devices for the conversion of rotational energy to mechanical or electrical energy by a plurality of means of reversible hydraulic pumps, pneumatic turbines, electric motors, or generators;
a plurality of means for the transmittance of the rotational energy to a plurality of rotational shafts;
a plurality of means for the conveyance of electrical energy to or from the reversible electric motors and generators;
a plurality of electrical buses;
a plurality of control systems; thereby said control systems automate said energy storage system;
thereby said control systems maximize the efficiency thereof;
means for connecting the energy storage system to a power grid; thereby providing means for the conveyance of energy to or from the energy storage system;
whereby, energy is stored by forcing said fluid, gas, or air into the bladders; thereby the energy from the conventional or renewable power sources compress the fluid by means of the energy conversion devices; thereby the compressed fluid, gas, or air is routed by means of said conduits to said bladders for storage thereof;
whereby, energy is recovered by forcing said fluid, gas, or air out of the bladders by the hydrostatic pressure of said water, heretofore.

16. The method and apparatus of claim 15, wherein said flexible compressed air storage bladders are composed of reinforcing elements; thereby providing means for the attachment of said anchor tethers thereof; wherein said reinforcing elements provide additional strength of the bladders;
whereby, said reinforcing elements are affixed to a membrane impervious to said water or said fluid, gas, or air; thereby the reinforcing members compose a composite structure thereof;
wherein said reinforcing elements aid to the structural integrity therein.

17. The method and apparatus of claim 15, wherein one side of said flexible, reinforced composite bladders are composed of a rigid, pressure resisting containment head; wherein the shape of the head is a section of revolution, not of cylindrical section, consisting of a rigid material capable of retaining its formed shape after repeated loading to design pressure;
whereby, said rigid, pressure resisting containment head adds structural integrity of said flexible, reinforced composite bladders; wherein permanent deformation does not occur, thereof.

18. The apparatus of claim 15, further including a plurality of means for reinforcing said flexible, reinforced composite bladders; wherein the reinforcing means are positioned in any manner, thereof.
